(19) United States
(12) Patent Application Publication
(10) Pub. No.: US 2010/0264048 A1
(43) Pub. Date: Oct. 21, 2010

(54) TEMPERATURE-CONTROLLED MUSICAL INSTRUMENT CARRYING CASE

(76) Inventor: Gabriel Sharkey Gunsberg, Boston, MA (US)

Correspondence Address: MORSE, BARNES-BROWN & PENDLETON, P.C.;ATTN: IP MANAGER, RESERVOIR PLACE, 1601 TRAPELO ROAD, SUITE 205, WALTHAM, MA, 02451, US

(21) Appl. No.: 12/425,073

(22) Filed: Apr. 16, 2009

(51) Int. Cl. A45C 11/00; B65D 81/38; G05D 23/00; F28F 13/12; F28F 27/00

(52) U.S. Cl. 206/314; 220/592.2; 165/287; 165/122; 165/11.1

(57) ABSTRACT

A temperature-controlled musical instrument carrying case for storing a musical instrument is provided. The musical instrument carrying case includes an insulated outer housing and an interior storage compartment that can store the musical instrument. In addition, the musical instrument carrying case includes a temperature sensitive device, a power source, a controller, and a heat-transfer device. The temperature sensitive device provides an indication of a temperature in the interior storage compartment to the controller. Based on the indication of the temperature, the controller generates and transmits a drive signal to the heat-transfer device. The heat-transfer device receives the drive signal from the controller and, based on the drive signal, at least selectively cools the interior storage compartment.

### BACKGROUND

1. Field of the Invention

A temperature-controlled musical instrument carrying case having an interior storage compartment for storing a musical instrument.

2. Background Art

A musical instrument can be damaged if exposed to hot or cold temperatures. Damage to the musical instrument can include a number of undesirable changes to the musical instrument, such as warping and cracking of wood in the musical instrument as well as softening of glue and/or varnish in the musical instrument. In addition, damage to the musical instrument may include increased stress and strain, which increases the musical instrument's chance of being damaged or broken if the musical instrument is bumped, jostled, or otherwise impacted with a force. Temperature changes can also cause metal in the musical instrument to expand or contract, causing stringed, brass, valved and other instruments to play out of tune.

Fluctuations in temperature and moisture content can also damage the musical instrument. Temperature fluctuations in the musical instrument can cause the musical instrument to expand and contract, which can create stress joints in the musical instrument. Furthermore, moisture changes in the musical instrument can cause the musical instrument to swell and shrink. Such expansion, contraction, swelling, shrinking, or a combination thereof in the musical instrument can damage the musical instrument beyond repair.

Also, when entering room temperature environments after exposing their instruments hot or cold environments, musicians are often forced to wait for long periods of time before opening their cases. This allows wooden parts to adjust slowly to their new environments and helps to avoid damage as a result of thermal shock. This can be particularly problematic if a musician is running late to a performance or rehearsal and needs immediate access to his or her instrument upon arrival.

### SUMMARY

A temperature-controlled musical instrument carrying case for storing a musical instrument is provided. The musical instrument carrying case includes an insulated outer housing and an interior storage compartment. The insulated outer housing surrounds the interior storage compartment, which is adapted to store the musical instrument. In addition, the musical instrument carrying case includes a temperature sensitive device, a power source, a controller, and a heat-transfer device. The temperature sensitive device, the power source, the controller, and the heat-transfer device are disposed between the insulated outer housing and the interior storage compartment.

The temperature sensitive device provides an indication of a temperature in the interior storage compartment to the controller and the power source supplies electrical power to the controller. Likewise, the controller receives the electrical power from the power source as well as the indication of the temperature from the temperature sensitive device. The temperature sensitive device may be a temperature sensor. The temperature sensor senses the temperature in the interior storage compartment and generates a temperature signal. The temperature signal indicates the temperature in the interior storage compartment and therefore provides the indication of the temperature. Based on the indication of the temperature, the controller obtains a determination of whether the temperature in the interior storage compartment is within a predetermined temperature range and, based on the determination, generates a drive signal. The heat-transfer device receives the drive signal from the controller and, based on the drive signal, at least selectively cools the interior storage compartment.

The heat-transfer device may be a bidirectional heat-transfer device to selectively heat and cool the interior storage compartment based on the drive signal. The bidirectional heat-transfer device may be a solid-state active heat pump. In operation, the heat pump transfers heat from the interior storage compartment to outside the insulated outer housing of the musical instrument carrying case. Furthermore, the bidirectional heat-transfer device may include inner and outer thermal conductors to establish a thermal gradient between the inner and outer thermal conductors.

The drive signal may have a predetermined polarity. Based on the predetermined polarity of the drive signal, the bidirectional heat-transfer device can selectively heat and cool the interior storage compartment of the musical instrument carrying case. For example, the controller may generate the drive signal having a first predetermined polarity when the controller determines that the temperature in the interior storage compartment is below the predetermined temperature range. Likewise, the controller may generate the drive signal having a second predetermined polarity when the controller determines that the temperature in the interior storage compartment is above the predetermined temperature range. The first predetermined polarity is opposite the second predetermined polarity.

The musical instrument carrying case may include an inner housing. The inner housing is disposed between the insulated outer housing and the interior storage compartment. The inner and outer housings define a ventilation passage or duct to transfer air between the heat-transfer device and the interior storage compartment. Furthermore, the heat-transfer device may include a fan to move the air between the heat-transfer device and the interior storage compartment. For example, the fan may move the air in the ventilation duct to the interior storage compartment. In addition, the inner housing may define vent holes through which the fan of the heat-transfer device can transfer air between the heat-transfer device and the interior storage compartment. The vent holes may be distributed in an uniform pattern through the inner housing to provide uniform distribution of heat transference between the interior storage compartment and the ventilation passage.

During operation, the heat-transfer device transfers heat from inside the musical instrument carrying case to outside the insulated outer housing of the case to cool the interior storage compartment. In addition, the case may include a cover. The cover encloses the insulated outer housing and includes a vent. The vent of the cover channels air from outside the insulated outer housing to outside the cover.

The musical instrument carrying case may include a user interface. The user interface is electrically connected to the controller and allows a user of the musical instrument carrying case to control the operative mode of the controller. Furthermore, the user interface may provide a notification that indicates an amount of electrical power stored in the power source.

The musical instrument carrying case may also include an audio recording system. The audio recording system is electrically connected to the power source and is in electrical communication with the user interface. The audio recording system records audio signals from outside the insulated outer housing of the musical instrument carrying case. In addition, the musical instrument carrying case may include a global positioning system (GPS). The GPS is embedded between the insulated outer housing and the interior storage compartment and is electrically connected to the power source. The GPS generates a signal having positioning information of the musical instrument carrying case.

The musical instrument carrying case may have an electrical plug that is electrically connected to the power source. The electrical plug can be inserted into an electrical outlet to provide an electrical connection between the electrical outlet and the power source.

### BRIEF DESCRIPTION OF THE DRAWINGS

FIG. 1 is a partial cut-away perspective view illustrating a temperature-controlled musical instrument carrying case including a power source, a controller, and a heat-transfer device to at least selectively cool an interior storage compartment of the musical instrument carrying case;

FIG. 2 is a diagrammatic sectional view taken along line 2-2 of FIG. 1 illustrating the musical instrument carrying case including an inner housing with a plurality of vent holes; and

FIG. 3 is a schematic diagram illustrating electrical connections in the musical instrument carrying case for the controller to control the heat-transfer device.

### DETAILED DESCRIPTION

Embodiments of the present invention generally provide a temperature-controlled musical instrument carrying case.

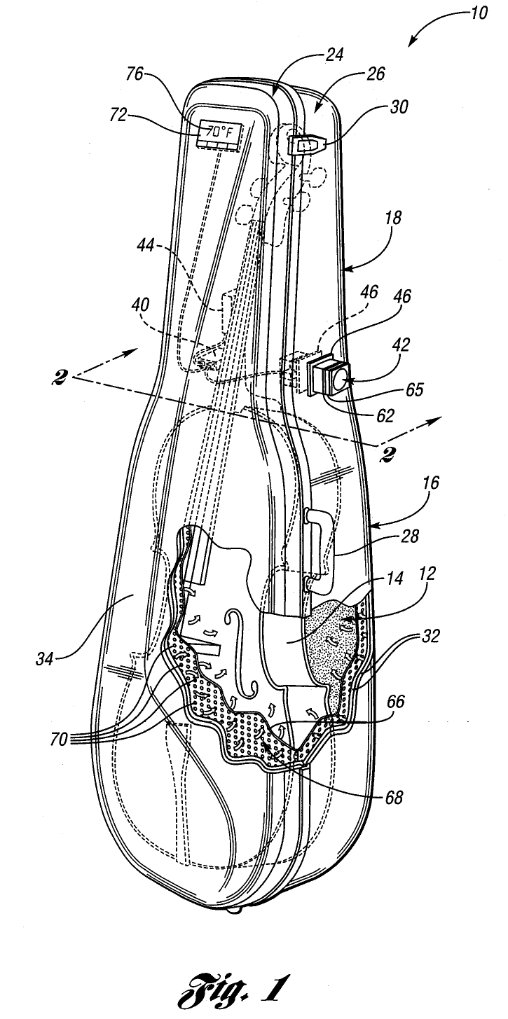

With reference to FIG. 1, a temperature-controlled musical instrument carrying case 10 (hereinafter “case”) is provided. The case 10 includes an interior storage compartment 12 (hereinafter “storage compartment”) for storing a musical instrument 14, such as a cello as shown in FIG. 1. However, the storage compartment 12 of the case 10 can be adapted to store a violin, guitar, clarinet, oboe, bassoon, drum, flute, trumpet, horn, or any type of musical instrument that can be carried in a case. The case 10 and its method of operation are described in an integrated manner to facilitate understanding of various aspects of the present invention.

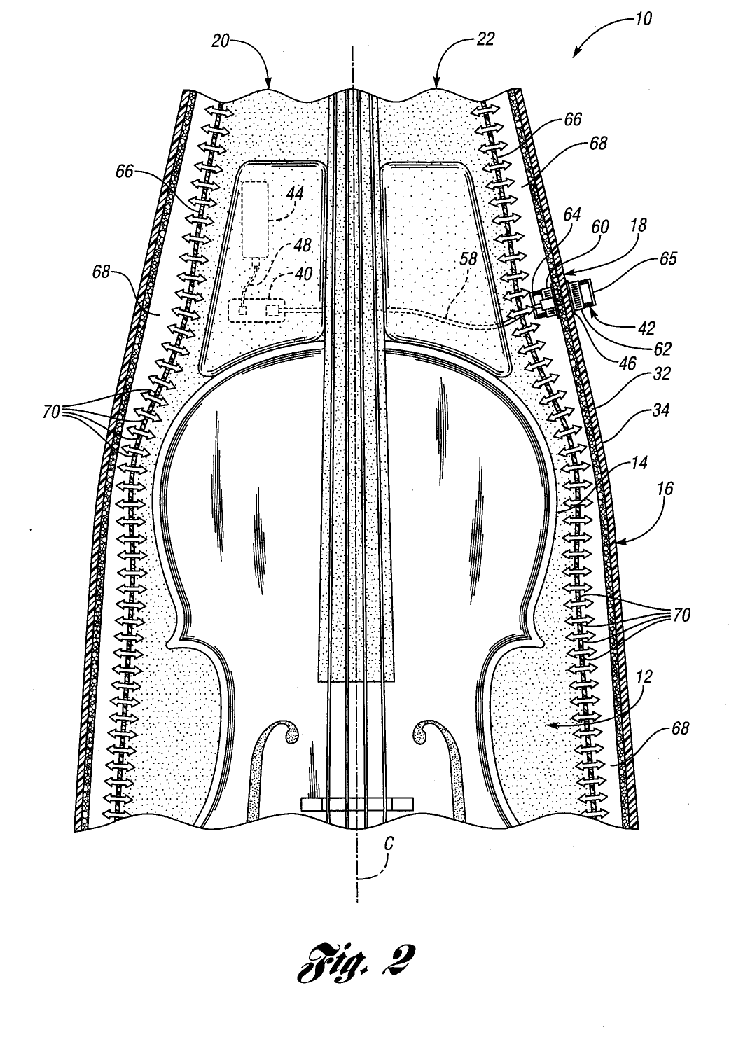

With continuing reference to FIG. 1, the case 10 may have a body portion 16 and a neck portion 18. The neck portion 18 extends up from the body portion 16 as shown in FIG. 1. As depicted in FIG. 2, a longitudinal axis C runs through the neck portion 18 of the case 10. Longitudinal axis C divides the neck portion 18 into a left neck portion 20 and a right neck portion 22.

Referring again to FIG. 1, the case 10 includes an upper lid 24 and a lower lid 26. The lower lid 26 is hingeably attached to the upper lid 24 to provide access to the storage compartment 12 to a user of the case 10. Furthermore, the case 10 may include a handle 28 and at least one fastener 30 to removably fasten the upper and lower lids 24, 26 together. In addition, the case 10 may include one or more shoulder straps (not shown) for carrying the case 10.

In operation, the case 10 controls the temperature in the storage compartment 12 in an effort to maintain the temperature in the storage compartment 12 within a predetermined temperature range. For example, the predetermined temperature range may be between 60 to 70 degrees Fahrenheit (60°-70° F.). The case 10 maintains the predetermined temperature range inside the case 10 even if an exterior of the case 10 is exposed to an extreme hot and/or cold temperature. Such an extreme hot or cold temperature, if exposed to the musical instrument 14, can damage the musical instrument 14. However, when the musical instrument 14 is stored in the storage compartment 12 while the case 10 is operating, the musical instrument 14 is protected from extreme hot and cold temperatures. In addition, the case 10 can be programmed with a number of different predetermined temperature ranges. The user may select the predetermined temperature ranges and program them into the case 10 depending on the temperature range that is optimal for the musical instrument 14. Naturally, the predetermined temperature range that is programmed into the case 10 excludes those extreme hot or cold temperatures that can potentially damage the musical instrument 14.

As illustrated in FIG. 2, the case 10 can include padding. The padding at least partially defines the storage compartment 12 for storing a musical instrument 14. In addition, the padding contacts various areas of the musical instrument 14 to support the musical instrument 14 in a predetermined position in the storage compartment 12. Furthermore, the padding provides shock-absorption in the event that the case 10 is bumped, dropped, or otherwise subjected to an impact. In addition to padding, the case 10 may include restraining straps to fasten the musical instrument 14 in the predetermined position in the storage compartment 12.

As shown in FIGS. 1-2, the case 10 includes an insulated outer housing (hereinafter “outer housing”) 32. The outer housing 32 has an outer surface 34. In addition, the outer housing 32 surrounds the storage compartment 12 of the case 10 to provide an insulating barrier between the storage compartment 12 and air surrounding the outer surface 34 of the case 10. Various materials may be used to construct the outer housing 32. For example, the outer housing 32 may be formed or molded from acrylonitrile butadiene styrene (ABS) plastic. ABS plastic provides the outer housing 32 with a relatively high impact resistance and may allow the outer housing 32 to be manufactured at a relatively low cost. In addition, ABS plastic can provide the outer housing 32 with a substantially-rigid protective shell that not only absorbs impacts, but also facilitates the attachment of insulation and other materials to the outer housing 32. In another example, the outer housing 32 may be formed or molded from ABS M30 plastic. A company called Stratasys may provide the ABS M30 plastic. ABS M30 plastic can provide the outer housing 32 with additional strength while allowing the outer housing 32 to have a thinner thickness than a standard ABS plastic outer housing. Therefore, a case made of ABS M30 plastic can be made lighter and easier for the user to transport. In another example, the outer housing 32 may be made from ULTEM. ULTEM is a high-performance thermoplastic that a company called SABIC may provide. ULTEM is a lighter and stronger material than ABS plastic. In another example, the outer housing 32 of the case 10 may be formed from fiberglass, carbon fiber, plastics, metal, or a combination of such materials.

Referring again to FIGS. 1-2, the outer housing 32 can be constructed from two layers of material, which are collectively referenced as numeral 32 in FIG. 1. However, the outer housing 32 can be constructed from a single sheet of material or composite, or from three or more layers of material. The outer housing 32 of FIGS. 1-2 can be constructed from ABS plastic and a foam to provide both impact resistance and a thermal barrier between the outer surface 34 of the case 10 and the storage compartment 12. The foam of the outer housing 32 may be a soft or semi-rigid foam, such as polyurethane, or other material with sufficient shock-absorbing properties and a high R value to contain heat inside the case 10. In addition, the soft or semi-rigid foam can protect the musical instrument 14 stored in the storage compartment 12 from damage in the event that the case 10 is bumped, dropped, or otherwise subjected to an impact. Furthermore, the outer housing 32 may be constructed from aerogel, an insulating material that various companies, such Aspen Aerogels or Cabot Corporation, can provide. Aerogel allows the case 10 to be relatively light and compact. In addition, a material called Cryogel Z may be used to seal in humidity. Aerogel may be attached using an adhesive, such as 3M Foam Insulation 78 Spray. Several layers of aerogel may be stacked on top of each other for additional insulation and to maximize the performance of the case 10.

As illustrated in FIGS. 1-2, the case 10 includes a controller 40, a heat-transfer device 42, and a power source 44. The controller 40, the heat-transfer device 42, and the power source 44 are at least partially disposed between the outer housing 32 and the storage compartment 12. As shown in FIGS. 1-3, the heat-transfer device 42 projects from the outer surface 34 of the outer housing 32 and is partially disposed between the outer housing 32 and the storage compartment 12. However, the heat-transfer device 42 may be recessed in the outer housing 32 of the case 10, such that the heat-transfer device 42 is not projecting out from the outer surface 34. Having the heat-transfer device 42 recessed in the outer housing 32 helps to prevent the heat-transfer device 42 from being damaged if the case 10 is dropped, bumped, or otherwise impacted. In addition, having the heat-transfer device 42 recessed in the outer housing 32 can also help to insure that the case 10 fits into airplane overhead compartments, lockers, and other storage compartments.

The heat-transfer device 42 of FIGS. 1-2 is shown projecting from a side of the case 10 having the handle 28. However, the heat-transfer device 42 may project from a front side of the case 10, a back side of the case 10, a side of the case 10 opposing the handle 28, or any other suitable portion of the outer surface 34 of the case 10. Because the heat-transfer device 42 extends through the outer housing 32 of the case 10, the heat-transfer device 42 may include a gasket 46 (shown in FIGS. 1-2). The gasket 46 is constructed from rubber, plastic, foam, or other suitable material to maintain an airtight seal between the heat-transfer device 42 and the outer housing 32 of the case 10. For example, the gasket 46 may be a waterproof sealing gasket.

As shown in FIG. 2, the heat-transfer device 42 may be positioned in one side of the neck portion 18 of the case 10 while the controller 40 and the power source 44 are positioned in another side of the neck portion 18. For example, the heat-transfer device 42 may be in the right neck portion 22 while both the controller 40 and the power source 44 are positioned in the left neck portion 20. Recall, longitudinal axis C represents the boundary between the left and right neck portions 20, 22. One reason to have the heat-transfer device 42 positioned in the right neck portion 22 and both the controller 40 and the power source 44 positioned in the left neck portion 20 is to create an even weight distribution or weight balance between the left and right neck portions 20, 22 of the case 10. Thus, the weight of the heat-transfer device 42 may balance the combined weight of the controller 40 and the power source 44 along longitudinal axis C that runs through the neck portion 18. In addition, the controller 40, the heat-transfer device 42, and the power source 44 may be located as close to the body portion 16 of the case 10 in an effort to lower the center of gravity of the case 10. This can help prevent the case 10 from tipping over when the case 10 is standing upright. Furthermore, positioning the controller 40, the heat-transfer device 42, and the power source 44 in the respective right and left neck portions 22, 20 as well as close to the body portion 16 of the case 10 makes the case 10 relatively compact and easier to transport.

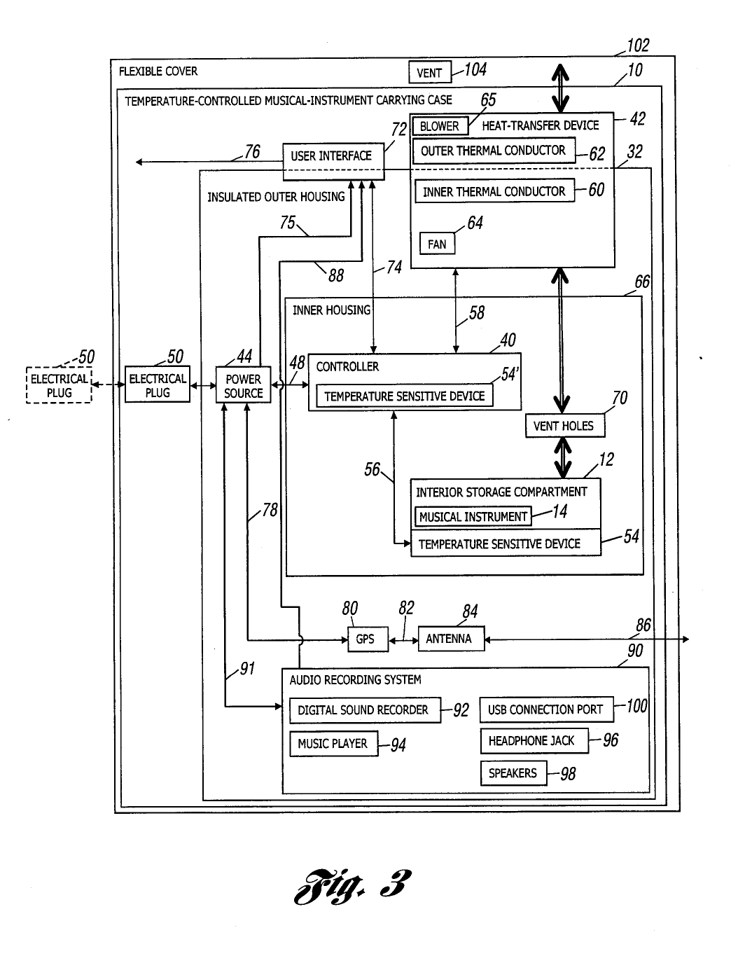

As illustrated in FIGS. 2-3, the power source 44 is disposed between the outer housing 32 and the storage compartment 12 to supply electrical power 48 to the controller 40, such as DC-power. The power source 44 can be a battery, such as a lithium ion battery or Ni-metal hydride battery. In addition, the battery may be a rechargeable battery.

Referring to FIG. 3, the case 10 may include an electrical plug 50. The electrical plug 50 may be housed within the case 10 to provide access to the electrical plug 50 even when the case 10 is closed. In addition, the electrical plug 50 may be retractable. The electrical plug 50 is electrically connected to the power source 44 for insertion into an electrical outlet (not shown). For example, the electrical plug 50 may be of the male-type to insert into a power outlet of an automobile (not shown). In another example, the electrical plug 50 may be of the male-type having three blades adapted to insert into a female-type electrical socket (not shown), such as those sockets found on household extension cords. Additionally, the electrical plug 50 may be adapted to insert into European or other foreign-type sockets. The electrical plug 50 provides an electrical connection between the electrical outlet (not shown) and the power source 44 when the electrical plug 50 is inserted into the electrical outlet. In operation, the electrical outlet provides electrical power to the power source 44, which may be used to supply electrical power 48 to the controller 40, recharge the battery of the power source 44 if the power source 44 is the rechargeable battery, or supply electrical power 48 to other components in the case 10.

As shown in FIGS. 1-3, the controller 40 is disposed between the outer housing 32 and the storage compartment 12. The controller 40 receives the electrical power 48 from the power source 44. In addition, the controller 40 obtains or receives an indication of the temperature in the storage compartment 12 in the case 10.

As shown in FIG. 3, the case 10 includes a temperature sensitive device 54. The temperature sensitive device 54 is disposed between the outer housing 32 and the storage compartment 12. The temperature sensitive device 54 may be part of the controller 40 (shown as temperature sensitive device 54′) or disposed as a separate component from the controller 40 (shown as temperature sensitive device 54), depending on the configuration of the case 10. The temperature sensitive device 54, 54′ provides the indication of the temperature in the storage compartment 12 to the controller 40. In one example, the temperature sensitive device 54, 54′ is a passive device, such as a bi-metal thermostat disposed within the controller 40. Alternatively, the temperature sensitive device 54, 54′ can be a temperature sensor.

Referring again to FIG. 3, the temperature sensor can be disposed within the controller 40 (shown as temperature sensitive device 54′), next to the storage compartment 12 (shown as temperature sensitive device 54), or in any other suitable position within the case 10. In operation, the temperature sensor (shown as temperature sensitive device 54) senses the temperature in the storage compartment 12 and generates a temperature signal 56 indicating the temperature in the storage compartment 12. Thus, the temperature in the storage compartment 12 is embedded or encoded in the temperature signal 56. Furthermore, the controller 40 receives the temperature signal 56 from the temperature sensitive device 54 to obtain the indication of the temperature in the storage compartment 12.

With continuing reference to FIG. 3, the controller 40 obtains the indication of the temperature in the storage compartment 12 from the temperature sensitive device 54, 54′ to determine whether the temperature in the storage compartment 12 is within the predetermined temperature range. Thus, the controller 40 obtains a determination of the temperature in the storage compartment 12 based on the indication of the temperature in the storage compartment 12. For example, the controller 40 can determine that the temperature in the storage compartment 12 is below a predetermined temperature (e.g., 60° F.), or below the predetermined temperature range (e.g., 60°-70° F.), to obtain a determination that the storage compartment 12 is too cold and therefore needs to be heated. In another example, the controller 40 can determine that the temperature in the storage compartment 12 is above a predetermined temperature (e.g., 70° F.), or above the predetermined temperature range (e.g., 60°-70° F.), to obtain a determination that the storage compartment 12 is too hot and therefore needs to be cooled. Based on whether the temperature in the storage compartment 12 is within the predetermined temperature range, the controller 40 controls the heating or cooling of the heat-transfer device 42. Thus, the controller 40 can be programmed to activate the heat-transfer device 42 whenever the controller 40 determines that the temperature in the storage compartment 12 falls outside the predetermined temperature range.

With continuing reference to FIG. 3, the controller 40 generates a drive signal 58 based on the whether the temperature in the storage compartment 12 is too cold, too hot, or within the predetermined temperature range. Furthermore, the controller 40 may generate the drive signal 58 with a predetermined polarity to indicate whether the storage compartment 12 is to be cooled or heated. The predetermined polarity can be either a positive polarity or negative polarity. For example, the controller 40 can generate the drive signal 58 having a first predetermined polarity when the controller 40 obtains the determination that the storage compartment 12 is too cold and therefore needs to be heated. On the other hand, when the controller 40 obtains the determination that the storage compartment 12 is too hot and therefore needs to be cooled, the controller 40 can generate the drive signal 58 having a second predetermined polarity, which is opposite in polarity to the first predetermined polarity. In such an example, the controller 40 can generate the drive signal 58 having a positive voltage for heating the storage compartment 12 and a negative voltage for cooling the storage compartment 12.

The controller 40 may operate to provide a number of other features. For example, the controller 40 may automatically shut down the heat-transfer device 42 if the controller 40 determines that the battery or the heat-transfer device 42 has overheated or a short-circuit has occurred.

As illustrated in FIGS. 1-3, the heat-transfer device 42 can be a thermoelectric heat-transfer device that includes an inner thermal conductor 60 and an outer thermal conductor 62. The inner and outer thermal conductors 60, 62 may be formed from any suitable conducting material, such as anodized aluminum. In operation, the heat-transfer device 42 receives the drive signal 58 from the controller 40. Based on the drive signal 58, the heat-transfer device 42 establishes a thermal gradient between the inner and outer thermal conductors 60, 62 of the heat-transfer device 42. The heat-transfer device 42 at least selectively cools the storage compartment 12 based on the drive signal 58. To cool the storage compartment 12, the heat-transfer device 42 establishes the thermal gradient between the inner and outer thermal conductors 60, 62 such that inner thermal conductor 60 is cooler than the outer thermal conductor 62. In such an example, the inner thermal conductor 60 acts as a heat sink because heat is transferred from the storage compartment 12 to the inner thermal conductor 60 while the outer thermal conductor 62 exhausts heat out of the case 10.

In addition to cooling the storage compartment 12, the heat-transfer device 42 may be a bidirectional heat-transfer device 42 to selectively heat and cool the storage compartment 12 based on the drive signal 58. The bidirectional heat-transfer device can employ the principles of the Peltier effect to heat, cool, or selectively heat and cool the storage compartment 12 of the case 10. During use, the bidirectional heat-transfer device 42 operates between heating and cooling based on the predetermined polarity of the drive signal 58. For example, the bidirectional heat-transfer device 42 receives the drive signal 58 having the first predetermined polarity, such as a positive voltage, from the controller 40 to heat the storage compartment 12. In such an example, the bidirectional heat-transfer device 42 establishes the thermal gradient between the thermal conductors such that the inner thermal conductor 60 has a higher temperature than the outer thermal conductor 62. When the inner thermal conductor 60 has the higher temperature than the outer thermal conductor 62, the heat-transfer device 42 heats the storage compartment 12. Similarly, the bidirectional heat-transfer device 42 can cool the storage compartment 12. The bidirectional heat-transfer device 42 receives the drive signal 58 having the second predetermined polarity, such as a negative voltage, from the controller 40. Based on the drive signal 58, the bidirectional heat-transfer device 42 establishes the thermal gradient between the thermal conductors 60, 62 such that the outer thermal conductor 62 has a higher temperature than the inner thermal conductor 60 thereby cooling the storage compartment 12. Thus, the bidirectional heat-transfer device 42 may heat the storage compartment 12 given one polarity of the drive signal 58 and cool the storage compartment 12 given a different polarity of the drive signal 58.

As shown in FIGS. 1-3, the case 10 includes a fan 64. The fan 64 may be part of the heat-transfer device 42 as shown in FIGS. 1-3. However, the fan 64 may be a separate component located outside the heat-transfer device 42. The fan 64 receives the electrical power 48 from the power source 44, such as through the controller 40, to move the air in the case 10 between the heat-transfer device 42 and the storage compartment 12. The controller 40 controls the fan 64 via the drive signal 58. For example, the controller 40 can switch on the fan 64 whenever the controller 40 determines that the temperature in the storage compartment 12 is not within the predetermined temperature range. In addition, the controller 40 can switch off the fan 64 whenever the controller 40 determines that the temperature in the storage compartment 12 is within the predetermined temperature range.

As shown in FIGS. 1-3, the case 10 may also include an exhaust fan or blower 65. The blower 65 may be part of the heat-transfer device 42 as shown in FIGS. 1-3. However, the blower 65 may be a separate component located outside the heat-transfer device 42. In operation, the blower 65 receives the electrical power 48 from the power source 44, such as through the controller 40, to blow air across the outer thermal conductor 62 of the heat-transfer device 42. Blowing air across the outer thermal conductor 62 facilitates either cooling or heating of the case 10 depending on the thermal gradient between the thermal conductors 60, 62 of the heat-transfer device 42. For example, when the inner thermal conductor 60 acts as the heat sink, the blower 65 can help exhaust heat away from the outer thermal conductor 62 to transfer heat out of the case 10.

As illustrated in FIGS. 1-3, the case 10 includes an inner housing 66 surrounding the storage compartment 12 of the case 10. The inner housing 66 can be formed from a signal sheet. However, the inner housing 66 may be formed from multiple sheets, depending on the case 10. The outer housing 32 encloses the inner housing 66 and therefor provides an extra layer of impact protection for the storage compartment 12 in the event that the case 10 is dropped, knocked, or otherwise subjected to an impact. Furthermore, the inner housing 66 is disposed between the outer housing 32 and the storage compartment 12. In addition, the inner housing 66 can be formed to include a number of chambers or recesses to house the various components in the case 10, such as the power source 44, the controller 40, the heat-transfer device 42, and the fan 64.

The inner housing 66 may be constructed from any suitable material, such as ABS plastic or other type of plastic. Alternatively, the inner housing 66 may be constructed from other types of relatively light materials to facilitate carrying, rolling, pulling, or otherwise transporting the case 10 from one location to another. In one example, the inner housing 66 may be constructed using a twin-sheet thermoforming process. During the twin-sheet thermoforming process, the inner housing 66 attaches to an upper portion of the outer housing 32. Alternatively, the inner housing 66 may be formed as a single piece separate from the outer housing 32 that is fastened to the outer housing 32 with one or more fasteners, such as an adhesive or screw. One or more parts of the case 10 may also be made using Direct Digital Manufacturing, which is a rapid, low-cost manufacturing process that a company called Stratasys employs.

While the inner housing 66 can be useful for air distribution and additional protection against impact, the case 10 may be made without it. In this situation, the air from the heat transfer device 42 can be blown directly into the interior storage compartment 12.

As shown in FIGS. 1-2, the inner and outer housings 34, 32 define a ventilation passage or duct (hereinafter “ventilation passage”) 68. The ventilation passage 68 channels or transfers the air in the case 10 that the fan 64 moves between the heat-transfer device 42 and the storage compartment 12. The air in the case 10 that is in the ventilation passage 68 carries or stores heat. Thus during operation, the fan 64 transfers the air in the ventilation passage 68 to and from the inner thermal conductor 60 of the heat-transfer device 42. The fan 64 circulates the air in the ventilation passage 68 to either remove heat from or add heat to the storage compartment 12 in the case 10. For example, the heat-transfer device 42 can establish the inner thermal conductor 60 at a lower temperature than the outer thermal conductor 62 while the fan 64 passes the cooled air in the case 10 across the inner thermal conductor 60, through the ventilation passage 68, and into the storage compartment 12 to cool the storage compartment 12. To heat the storage compartment 12, the heat-transfer device 42 establishes the inner thermal conductor 60 at a higher temperature than the outer thermal conductor 62 while the fan 64 passes the warmed air in the case 10 across the inner thermal conductor 60, through the ventilation passage 68, and into the storage compartment 12. In either case, the fan 64 moves the air in the case 10 that is in the ventilation duct across the inner thermal conductor 60 of the heat-transfer device 42 towards the storage compartment 12 to either heat or cool the storage compartment 12 of the case 10.

The inner housing 66 of FIG. 2 defines a plurality of vent holes 70. The vent holes 70 may be any shape or size depending the type of musical instrument that the case 10 is adapted to store. For example, the vent holes 70 may be larger for a case 10 adapted to store a cello than a case 10 adapted to store a violin. In operation, the fan 64 transfers the air in the case 10 between the heat-transfer device 42 and the storage compartment 12 through the vent holes 70.

The vent holes 70 may be circular and distributed in the inner housing 66 so that temperature-sensitive areas of the musical instrument 14 receive heated or cooled air in the case 10 from the heat-transfer device 42 at the greatest rate. Temperature-sensitive areas of the musical instrument 14 includes those areas of the musical instrument 14 where the musical instrument 14 is prone to damage or fatigue when the temperature of the musical instrument 14 is outside the predetermined temperature range. In addition, the vent holes 70 may be distributed in a pattern in the inner housing 66 such that when the fan 64 transfers the air in the case 10 between the heat-transfer device 42 and the storage compartment 12, the air flowing through the vent holes 70 is uniformly distributed within the storage compartment 12. For example, the vent holes 70 may be distributed along the entire length of the inner housing 66 to provide even distribution of conditioned inside air to the musical instrument 14 stored in the storage compartment 12. Alternatively, the vent holes 70 may be distributed as clusters within the storage compartment 12 at strategically-positioned locations in the inner housing 66.

The ventilation passage 68 may include a series of tubes or ducts running from the heat-transfer device 42 to the vent holes 70 in the inner housing 66. The series of tubes or ducts may be constructed as recesses in the inner housing 66, or as separate parts that are attached to the inner housing 66. Alternatively, the series of tubes or ducts can be formed using the twin-sheet thermoforming process of the outer housing 32.

As shown in FIGS. 1 and 3, the case 10 may include a user interface 72. Electrical connection 74 electrically connects the user interface 72 and the controller 40. In addition, the user interface 72 may receive electrical power from the power source 44 along electrical connection 75 or indirectly from the controller 40 along electrical connection 74. As illustrated in FIG. 1, the user interface 72 is shown positioned on or within the outer surface 34 of the outer housing 32 near the top of the case 10. For example, the user interface 72 may be recessed in the outer housing 32 of the case 10, such that the user interface 72 is not projecting out from the outer surface 34. Having the user interface 72 recessed in the outer housing 32 helps to prevent the user interface 72 from being damaged if the case 10 is dropped, bumped, or otherwise impacted. However, the user interface 72 may be positioned in any suitable portion of the case 10 where the case 10 is least likely to experience an impact to the outer housing 32. For example, the user interface 72 may be positioned near the handle 28 or on a back part of the outer surface 34 of the case 10 to reduce the chance that the user interface 72 will be impacted or exposed while being transported, such as when the user of the case 10 is carrying the case 10 on his or her back like a backpack. In another example, the user interface 72 may be positioned in the storage compartment 12.

Positioning the user interface 72 on or within the outer surface 34 of the outer housing 32 allows the user of the case 10 to operate the user interface 72 without having to open the case 10. With the case 10 closed, the user can operate the user interface 72 without subjecting the musical instrument 14 stored in the storage compartment 12 to various elements that exist around or outside the case 10, such as rain, snow, excessive heat, excessive cold temperatures, wind, etc.

The user interface 72 allows the user of the case 10 to at least control the operative mode of the controller 40. For example, the user can switch on the controller 40 when the user wants the controller 40 to control the heat-transfer device 42. In contrast, the user can switch off the controller 40 when the user does not want the controller 40 to operate. The user may want to switch off the controller 40 when the case 10 does not have the musical instrument 14 stored in the storage compartment 12 or when the user wants to save an amount of electrical power stored in the power source 44. The user interface 72 could be a touch-sensitive display where the user presses icons or symbols representing the on and off modes of the controller 40. Alternatively, the user interface 72 could be a combination of a digital display, such as a liquid crystal display (LCD), and a series of buttons, mechanical switches, or other input devices.

The user interface 72 also allows the user of the case 10 to set or change the predetermined temperature range for the storage compartment 12. For example, the user may input a new predetermined temperature range using the touch-sensitive display to reprogram the controller 40 with the new predetermined temperature range.

As shown in FIGS. 1 and 3, the user interface 72 may provide one or more notifications 76 to the user of the case 10. The notification 76 can be either an audible sound notification, a visual notification, or a combination of both. Furthermore, the notification 76 can indicate a number of operations or conditions of the case 10.

In a first example, the notification 76 can indicate the amount of electrical power stored in the power source 44. The controller 40 can monitor the amount of electrical power stored in the power source 44 and provide a power signal embedded or encoded with the amount of electrical power stored in the power source 44. The controller 40 transmits the power signal through electrical connection 74 to the user interface 72. The notification 76 can indicate the amount of electrical power stored in the power source 44 as a symbol or a blinking light displayed on the user interface 72 to alert the user that the power source 44 is running low, and that the user should consider either replacing or recharging the power source 44. Alternatively, the notification 76 may include an a sequence of audible beeps or other warning noise to alert the user that the electrical power stored in the power source 44 is running low. The sequence of audible beeps may occur at closer intervals as the amount of electrical power stored in the power source 44 is reduced.

In a second example, the notification 76 can display the amount of electrical power stored in the power source 44 as a sequence of “power bars” that display the power remaining in the power source 44 (similar to the battery-life bars displayed on a cell phone). Alternatively, the notification 76 can display the amount of electrical power stored in the power source 44 as a battery symbol that displays the remaining power.

In a third example, the notification 76 can indicate the operative mode of the heat-transfer device 42. Such information about the operative mode can be transmitted to the user interface 72 from the controller 40 along the electrical connection 74. Such a notification can be displayed on the user interface 72 and show whether the heat-transfer device 42 is on, off, idle, working, etc. In such an example, the notification 76 may include one or more colored lights, with each light indicating a different operative mode of the heat-transfer device 42. For example, the notification 76 can include an illuminated green light to indicate that the heat-transfer device 42 is transferring heat, a yellow light to indicate that the heat-transfer device 42 is idle, and a red light to indicate that the heat-transfer device 42 is off.

In a fourth example, the notification 76 can indicate the temperature in the storage compartment 12 in the case 10. This type of notification may be displayed on the digital display or the touch-sensitive display as a digital number, symbol, or other graphical representation. Such information about the temperature in the storage compartment 12 can be transmitted to the user interface 72 from the controller 40 along the electrical connection 74. Alternatively, this type of notification may be displayed using a non-digital device, such as a gauge having a needle that points to a number having the temperature in the storage compartment 12.

As illustrated in FIG. 3, the case 10 may include a computerized locating device or a global positioning system (GPS) 80 electrically connected to the power source 44 along electrical connection 78. The GPS 80 generates a position signal 82 embedded or encoded with positioning information of the case 10 and transmits the position signal 82 to an antenna 84. The antenna 84 receives the position signal 82 and transmits a wireless signal 86 having the positioning information outside the case 10 where a wireless device (not shown) can receive the wireless signal 86 from the antenna 84. The wireless device may be a personal digital assistant (PDA), a mobile phone, a notebook computer, etc. The antenna 84 may send the wireless signal 86 to the wireless device so that the user is able to track the position of the case 10 at any given time with the wireless device.

As shown in FIG. 3, the GPS 80 can be embedded between the outer housing 32 and the storage compartment 12, such that the GPS 80 is installed inside the case 10. The GPS 80 can provide a number of benefits. For example, the GPS 80 can help the user locate the position of the case 10. This may be beneficial in the event that the case 10 is a checked into or unloaded from an airplane, especially since some airlines have been known to lose checked baggage. Furthermore, the GPS 80 may allow the user to track the position of the case 10 in the event that the case 10 is lost, stolen, or in transit.

With continuing reference to FIG. 3, the case 10 may include an audio recording system 90. The audio recording system 90 is in electrical communication with the user interface 72 through electrical connection 88. In addition, the audio recording system 90 is electrically connected to the power source 44 along electrical connection 91. The audio recording system 90 is at least partially built-in between the outer housing 32 and the storage compartment 12. Or, the audio recording system 90 could be located inside the case 10 and record when the case 10 is open in front of a musician(s). The audio recording system 90 includes a digital sound recorder 92 to record audio signals from outside the outer housing 32 of the case 10. Furthermore, the audio recording system 90 may include an audio or music player 94, such as an mp3 player. Furthermore, the audio recording system 90 may include a headphone jack 96, one or more speakers 98, or a combination of both for the user to listen the recorded sounds. In fact, the audio recording system 90 may have several headphone jacks so that all of the members of a string quartet, for example, can listen to the recordings of their rehearsals at the same time.

The headphone jack 96 may be placed on the side or back of the case 10 at about head or shoulder level when the case 10 is being carried like a backpack. This would allow the user to listen to any music, including his or her own recordings, while walking with the case 10. The headphone jack 96 could have a rubber, plastic, or other waterproof cover to protect the headphone jack 96 when the case 10 is carried in the rain. For example, the cover could include a “male” part to insert into a hole of the headphone jack 96. The cover could also include a hingeable or flexible housing that closes over the headphone jack 96.

Furthermore, the audio recording system 90 may include a USB connection port 100 for uploading a sound recording to a computer (not shown). For example, the user may have recorded the sound recording while practicing or performing. Once uploaded to the computer, the user could archive the sound recordings on the computer, email the sound recordings to teachers or friends, and/or manipulate the sound recordings using a software program, such as Protools. In addition, the user may use the USB connection port 100 to upload sound recordings of a favorite musician and listen to the sound recordings using the audio recording system 90 without having to carry a separate audio player, such as an mp3 player.

The audio recording system 90 provides a number of benefits. For example, having the audio recording system 90 built into the case 10 can be very convenient to the user of the audio recording system 90 because the audio recording system 90 would allow the user to easily record sounds from a player practicing or performing near the musical instrument 14. Later, the user can playback the recording and listen to any mistakes that the player made while playing the musical instrument 14. Thus, the player would be able to immediately work to correct the mistakes, such as in a practice room. Furthermore, the audio recording system 90 provides the user of the case 10 with a convenient and accessible audio system without the user having to worry about carrying around a separate small audio recorder, which can be easily lost or stolen.

As illustrated in FIG. 3, the case 10 may include a cover 102. The cover 102 encloses the outer housing 32 and includes a vent 104. The vent 104 channels the air that surrounds the outer surface 34 of the case 10 to outside the cover 102. For example, the cover 102 may be used to move heated air surrounding the outer thermal conductor 62 of the heat-transfer device 42, through the vent 104 in the cover 102, to outside the cover 102. Thus, the cover 102 is adapted to go over the case 10 and provide ventilation for the case 10. Being adapted to go over the case 10, the cover 102 may be flexible and include an access port to allow the electrical plug 50 to pass through the cover 102. The cover 102 may be made of nylon, plastic, rubber, or other durable, weather-resistant materials. In addition, the cover 102 may include handles, shoulder straps, wheels, foot pegs, and other accessories to make the cover 102 more portable and mobile.

The vent 104 may be an opening through which the heat-transfer device 42 protrudes. For example, the vent 104 may also be a hole, or a series of holes, lines, or other shapes that allow air to pass from the outer surface of the cover 102 to the heat-transfer device 42. In addition, the vent 104 may be a mesh made out of rubber, plastic, nylon, or other suitable materials. In addition to providing ventilation, the vent 104 in the cover 102 may prevent water or other moisture from flowing from outside the cover 102 to inside the cover 102. Furthermore, the cover 102 provides additional thermal and impact protection of the musical instrument 14 stored in the case 10. The cover 102 may be constructed from a soft or semi-rigid material, rigid material, or combination of materials to protect against thermal shock and abuse. For example, the cover 102 may be made of polyurethane or other material with good insulating and shock absorption properties. Such additional protection may be needed in the event that the case 10 is checked as luggage or cargo on an airplane, or stored in a car or bus with other objects that could jostle or fall on the case 10.

In addition, the cover 102 may include a fibrous silica-based aerogel blanket. The aerogel blanket may include a vapor barrier. The aerogel blanket may be attached to the cover 102 or to the insulated outer housing 32 using an adhesive, such as “3M Foam Insulation 78 Spray.” Several layers of the aerogel blanket may be stacked on top of each other for additional insulation and to maximize performance of case 10. In one example, the cover 102 may be made of a material called Cryogel Z. Aspen Aerogels can provide Cryogel Z. Cryogel Z may also be used to construct the outer housing 32. Butyl foil sealing tape or other sealing materials can be used during fabrication of the cover 102 and/or the case 10 to ensure that the vapor barrier properly seals the cover 102 and/or the case 10. Cryogel Z provides the vapor barrier and therefore can help keep the storage compartment 12 of the case 10 from losing moisture when the case 10 is held in the cargo hold of an airplane, where moisture is drawn out during flight. Dry air can be very harmful to the musical instrument 14, especially if the musical instrument 14 is constructed from wood or other moisture-sensitive material and/or if the upper and lower lids 24, 26 do not create an airtight seal when closed together. In addition, the cover 102 may include a zipper, a series of clips, and/or other mechanisms to close the cover 102. In addition, the cover 102 may have an interlocking male-to-female gasket seal around its edges.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A temperature-controlled musical instrument carrying case having an interior storage compartment for storing a musical instrument, the case comprising:
an insulated outer housing surrounding the interior storage compartment of the musical instrument carrying case;
a temperature sensitive device disposed between the insulated outer housing and the interior storage compartment to provide an indication of a temperature in the interior storage compartment;
a power source disposed between the insulated outer housing and the interior storage compartment to supply electrical power;
a controller disposed between the insulated outer housing and the interior storage compartment to receive electrical power from the power source, to receive the indication of the temperature from the temperature sensitive device, to obtain a determination of whether the temperature in the interior storage compartment is within a predetermined temperature range based on the indication of the temperature, and to generate a drive signal based on the determination; and
a heat-transfer device disposed between the insulated outer housing and the interior storage compartment to receive the drive signal from the controller and at least selectively cool the interior storage compartment of the musical instrument carrying case based on the drive signal.

2. The musical instrument carrying case of claim 1 wherein the heat-transfer device is a bidirectional heat-transfer device to selectively heat and cool the interior storage compartment of the musical instrument carrying case based on the drive signal from the controller.

3. The musical instrument carrying case of claim 2 wherein the drive signal has a predetermined polarity and the bidirectional heat-transfer device selectively heats and cools the interior storage compartment of the musical instrument carrying case based on the predetermined polarity of the drive signal.

4. The musical instrument carrying case of claim 2 wherein the controller generates the drive signal having a first predetermined polarity when the determination indicates the temperature in the interior storage compartment is below the predetermined temperature range and generates the drive signal having a second predetermined polarity when the controller determines the temperature in the interior storage compartment is above the predetermined temperature range, the first predetermined polarity being opposite the second predetermined polarity.

5. The musical instrument carrying case of claim 2 wherein the bidirectional heat-transfer device is a solid-state active heat pump that transfers heat from the interior storage compartment to outside the insulated outer housing of the musical instrument carrying case.

6. The musical instrument carrying case of claim 1 further including an inner housing disposed between the insulated outer housing and the interior storage compartment, the inner and outer housings defining a ventilation passage to transfer air between the heat-transfer device and the interior storage compartment, and the heat-transfer device including a fan to move the air between the heat-transfer device and the interior storage compartment.

7. The musical instrument carrying case of claim 6 wherein the inner housing defines a plurality of vent holes through which the fan of the heat-transfer device transfers the air between the heat-transfer device and the interior storage compartment.

8. The musical instrument carrying case of claim 7 wherein the plurality of vent holes are distributed in an uniform pattern through the inner housing to provide uniform distribution of heat transference between the interior storage compartment and the ventilation passage.

9. The musical instrument carrying case of claim 1 wherein the heat-transfer device transfers heat outside the insulated outer housing of the musical instrument carrying case to cool the interior storage compartment of the musical instrument carrying case.

10. The musical instrument carrying case of claim 9 further including a cover enclosing the insulated outer housing and including a vent to channel air storing heat from outside the insulated outer housing to outside the cover.

11. The musical instrument carrying case of claim 1 further including a user interface electrically connected to the controller to allow a user of the musical instrument carrying case to control the operative mode of the controller.

12. The musical instrument carrying case of claim 11 wherein the user interface provides a notification indicating an amount of electrical power stored in the power source.

13. The musical instrument carrying case of claim 11 further including an audio recording system electrically connected to the power source to record audio signals from outside the insulated outer housing of the musical instrument carrying case, the audio recording system being in electrical communication with the user interface.

14. The musical instrument carrying case of claim 1 further including a global positioning system embedded between the insulated outer housing and the interior storage compartment, the global positioning system being electrically connected to the power source to generate a signal having positioning information of the musical instrument carrying case.

15. The musical instrument carrying case of claim 1 further including an electrical plug electrically connected to the power source for insertion into an electrical outlet, the electrical plug providing an electrical connection between the electrical outlet and the power source when the electrical plug is inserted into the electrical outlet.

16. A temperature-controlled musical instrument carrying case having an interior storage compartment for storing a musical instrument, the case comprising:
an inner housing surrounding the interior storage compartment of the musical instrument carrying case;
an insulated outer housing enclosing the inner housing;
a bidirectional thermoelectric heat-transfer device having an inner thermal conductor and an outer thermal conductor to establish a thermal gradient between the inner thermal conductor and the outer thermal conductor;
the inner and outer housings defining a ventilation duct to transfer air storing heat between the inner thermal conductor of the thermoelectric heat-transfer device and the interior storage compartment;
a battery disposed between the insulated outer housing and the interior storage compartment to supply electrical power;
a fan receiving electrical power from the battery to move the air in the ventilation duct to the interior storage compartment;
a temperature sensitive device disposed between the insulated outer housing and the interior storage compartment to provide an indication of a temperature in the interior storage compartment;
a controller disposed between the insulated outer housing and the interior storage compartment to receive electrical power from the battery, to receive the indication of the temperature from the temperature sensitive device, to obtain a determination of whether the temperature in the interior storage compartment is within a predetermined temperature range based on the indication of the temperature, and to generate a drive signal based on the determination;
wherein the bidirectional thermoelectric heat-transfer device receives the drive signal from the controller to establish the thermal gradient between the inner and outer thermal conductors and the fan moves the air in the ventilation duct across the inner thermal conductor of the heat-transfer device towards the interior storage compartment to selectively heat and cool the interior storage compartment of the musical instrument carrying case.

17. A temperature-controlled musical instrument carrying case having an interior storage compartment for storing a musical instrument, the case comprising:
an inner housing surrounding the interior storage compartment of the musical instrument carrying case;
an insulated outer housing surrounding the inner housing such that the insulated outer housing and the inner housing define a ventilation duct to transfer air to the interior storage compartment;
a battery disposed between the outer housing and the interior storage compartment of the musical instrument carrying case to supply electrical power;
a temperature sensor disposed between the insulated outer housing and the interior storage compartment to sense a temperature in the interior storage compartment of the musical instrument carrying case and generate a temperature signal indicating the temperature in the interior storage compartment;
a controller disposed between the insulated outer housing and the interior storage compartment to receive the electrical power from the battery, to receive the temperature signal from the temperature sensor, and to generate a drive signal based on whether the temperature in the interior storage compartment is within a predetermined temperature range; and
an electrically-controllable heat-transfer device at least partially disposed in the ventilation duct as well as being configured to receive the drive signal from the controller and selectively transfer heat to and from the interior storage compartment of the musical instrument carrying case based on the drive signal thereby selectively heating and cooling the interior storage compartment of the musical instrument carrying case.

18. The musical instrument carrying case of claim 17 wherein the drive signal has a predetermined polarity and the heat-transfer device selectively transfers heat to and from the interior storage compartment based on the predetermined polarity of the drive signal, the heat-transfer device transferring air storing the heat from the ventilation duct to the interior storage compartment when the drive signal has first predetermined polarity, and the heat-transfer device transferring air storing the heat from the interior storage compartment to the ventilation duct when the drive signal has second predetermined polarity, the first predetermined polarity being opposite the second predetermined polarity.

19. The musical instrument carrying case of claim 17 wherein the heat-transfer device is a thermoelectric heat-transfer device to establish a thermal gradient between the ventilation duct and outside the musical instrument carrying case to change the temperature in the interior storage compartment.

20. The musical instrument carrying case of claim 17 further including a fan and wherein the inner housing defines a plurality of vent holes through which the fan moves the air between the heat-transfer device and the ventilation duct to transfer heat between the heat-transfer device and the interior storage compartment.
